(19) United States
(12) Patent Application Publication
(10) Pub. No.: US 2022/0188916 A1
(43) Pub. Date: Jun. 16, 2022

(54) ARTIFICIAL INTELLIGENCE EVALUATION SYSTEM USING COLLECTED INFORMATION ON ALTERNATIVES AND SELECTIONS

(71) Applicant: Bid My Listing, Inc., Newport Beach, CA (US)

(72) Inventor: Matt Proman, (US)

(73) Assignee: Bid My Listing, Inc., Newport Beach, CA (US)

(21) Appl. No.: 17/683,029

(22) Filed: Feb. 28, 2022

Related U.S. Application Data
(63) Continuation-in-part of application No. 16/995,752, filed on Aug. 17, 2020.
(60) Provisional application No. 62/888,499, filed on Aug. 18, 2019.
(60) Provisional application No. 63/155,712, filed on Mar. 2, 2021.

(51) Int. Cl. G06Q 30/08; G06Q 50/16

(52) U.S. Cl. CPC G06Q 30/08; G06Q 50/16

(57) ABSTRACT

An artificially intelligent communications apparatus comprises a central processing unit. Databases store at least three numerically quantifiable attributes associated with bids. The databases are in communication with the central processing unit. An input communications channel receives a plurality of bids, each of the bids comprising a numerical value for the first, second and third numerically quantifiable attributes and bid identification information. A non-volatile memory bears a software program which controls the central processing unit to store the numerically quantifiable attributes and their associated bid identification information together with information whether the bid was selected, select those bids in a particular auction which share common characteristics and determine a magnitude of difference in the numerically quantifiable attribute which causes a bid selection compared to less favorable rejected bids within the same auction to determine a magnitude of difference in the numerically quantifiable attribute causing a bid selection. A selected bid from an agent is compared to other bids on the same property to generate a suggested bid derived from a marginal driver quantum and a numerically quantifiable attribute.

### CROSS REFERENCE TO RELATED APPLICATIONS

This application is a continuation-in-part of non-provisional U.S. patent application Ser. No. 16/995,752, filed Aug. 17, 2020, entitled Real Estate Communications System and Method for Distributing Real Estate Listing Information, and Collecting Commitment Information and claims the benefit of the priority of that non-provisional patent application. This application also claims the benefit of U.S. Provisional patent application Ser. No. 62/888,499, filed Aug. 18, 2019, entitled Real Estate Communications System and Method for Distributing Real Estate Listing Information, and Collecting Commitment Information, and U.S. Provisional patent application Ser. No. 63/155,712, filed Mar. 2, 2021, entitled Real Estate Communications System and Method for Distributing Real Estate Listing Information, and Collecting Commitment Information. The disclosures of the above non-provisional patent application and the above two provisional patent applications are hereby incorporated herein by reference.

### TECHNICAL FIELD

The invention relates to an artificial intelligence apparatus and method for evaluating numerical and qualitative data on the basis of selected data digested from large amounts of collected information on homeowner options and selections in connection with a novel real estate transaction.

### STATEMENT REGARDING FEDERALLY SPONSORED RESEARCH OR DEVELOPMENT

(Not applicable)

### BACKGROUND OF THE INVENTION

Conventionally, it is known that when an individual decides to sell real property, for example a home, success in obtaining a good price within a reasonable amount of time is correlated to the degree of exposure of the availability of the property to potential buyers and the quality of the agent in terms of being hard-working, able to interface with potential buyers, and so forth. Exposure, for example by a homeowner working without an agent, was often achieved by widely advertising the property in the general geographical area within which the property was located. Seeking to obtain an additional degree of exposure, many sellers sought the assistance of a real estate agent. Employing a real estate agent, while entailing the payment of a commission, could dramatically increase the probability of a sale at a good price, for example where an agent had a strong reputation or a large following, or worked hard and advertised widely to turn up leads on potential buyers. Under an arrangement of this sort, a trusted agent is given a period of exclusivity, for example 3 to 6 months within which to sell the property. An individual with this exclusive agreement is often referred to as the “listing agent.”

It is noted that the terms “realtor,” “listing agent,” “broker,” “agent” and so forth are used in different ways by different persons, particularly lay persons. Notwithstanding the terminology used herein the general principles of the inventive communications apparatus and artificial intelligence apparatus are meant to facilitate decision-making, communications and the execution of tasks involving the owner of a property such as a house, apartment or boat and those professionals assisting in the sale or rental of the same.

Traditionally, listing agents have sought to increase their effectiveness by joining a multiple listing service (“MLS”). Under such an arrangement, a package of services is provided to real estate agents to allow them to establish contractual offers of compensation among agents, allows each of them to see one another's listings of properties for sale and enable a number of agents to attempt to sell a particular property, as well as to accumulate and disseminate information to enable appraisals.

If a property is marketed under a multiple listing service, the commission is shared between the buy side agent and the seller's agent. As a first step, the total compensation amount is typically determined by the seller and the seller's agent. Generally, the seller's agent, as the listing agent, then advises all other MLS participants what the amount of compensation to the buyer's agent will be. Compensation to the buyer's agent can take the form of a percentage of the sales price or a fixed dollar amount. However, a buyer's agent is free to negotiate the amount of the commission with the seller's agent.

Today, Internet-based services are used to expand wholesaling efforts beyond conventional pre-Internet marketing activities over, the essentials have not changed and marketing proceeds on the basis of the above principles. Generally, enterprises operating real estate databases make information respecting properties (such as location, asking sales price, listing agent(s) and so forth) more widely available, thus increasing the likelihood of a sale at a good price within a reasonable period of time. Typically, real estate databases gather information by attracting buyers, sellers, landlords and potential tenants to their website and collecting information useful in facilitating a real estate transaction. In addition, database operators access multiple listing services to collect additional information, to further enable their goal of providing information aimed at facilitating the consummation of real estate transactions.

As a general rule, database operators charge nothing to the buyer or seller or their agents for the sales which they help to enable. Rather, they generate income by banner advertising, the sale of apps and other services.

### SUMMARY OF THE INVENTION

While Internet-based services of the type described above are useful in facilitating the dissemination of information, they are inherently incapable of providing personalized services of the type which may be focused on the sale of a particular property. Such activities essentially remain within the exclusive purview of real estate agents. Accordingly, obtaining a listing agent with the economic muscle to market a property and a commitment to vigorously do the same are critical to a seller's or landlord's obtaining a good price within a reasonable period of time.

[11] In accordance with the invention an artificially intelligent communications apparatus comprises a central processing unit. A first database stores a numerically quantifiable first attribute. The first database is in communication with the central processing unit. A second database stores a numerically quantifiable second attribute, the second database being in communication with the central processing unit. A third database stores a numerically quantifiable third attribute, the third database being in communication with the central processing unit. An input communications channel receives a plurality of bids, each of the bids comprising a numerical value for the first, second and third numerically quantifiable attributes and bid identification information. A non-volatile memory bears a software program. The software program controls the central processing unit (i) to store, for each bid, the first, second and third numerically quantifiable attributes and their associated bid identification information together with information whether the bid was selected, (ii) for a particular auction select those bids in which the second and third numerically quantifiable attributes are the same or within a specified numerical range and store the same in a first normalized database, (iii) for a particular auction select those bids in which the first and third numerically quantifiable attributes are the same or within a specified numerical range and store the same in a second normalized database, (iv) for a particular auction select those bids in which the first and second numerically quantifiable attributes are the same or within a specified numerical range and store the same in a third normalized database, (v) for the first numerically quantifiable attribute determine a magnitude of difference in the first numerically quantifiable attribute causing a bid selection compared to less favorable rejected bids within the first normalized database by comparing bids within the first normalized database to each other to generate a first marginal driver (the difference needed to make a bid successful compared to other bids); (vi) for the second numerically quantifiable attribute determine a magnitude of difference in the second numerically quantifiable attribute causing a bid selection compared to less favorable rejected bids within the second normalized database by comparing bids within the second normalized database to each other to generate a second marginal driver; (vii) for the third numerically quantifiable attribute determine a magnitude of difference in the third numerically quantifiable attribute causing a bid selection compared to less favorable rejected bids within the third normalized database by comparing bids within the third normalized database to each other to generate a third marginal driver. A selected bid from an agent is compared to other bids on the same property to generate a suggested bid derived from a marginal driver value and a numerically quantifiable attribute.

While, for purposes of illustration, this specification often makes reference to a real estate buyer and seller, it is understood that this is merely an example of the application of the invention which may also be applied to the renting of properties by landlords to tenants.

The importance of the seller or landlord retaining an effective listing agent may be understood by considering several potential scenarios which illustrate how obtaining a good price within a reasonable period of time might be inhibited. For example, a listing agent may not have the financial resources to advertise the property. Also, if the listing agent has a limited number of properties, he may be tempted to keep the listing to himself and only sell it to buyers who approach him or his agency directly, thus ensuring that such a listing agent retains the entire commission. However, the most insidious possibility is that the listing agent will focus his efforts on accumulating a large number of listings, put them out over the multiple listing service, and then just wait for other agents to do the work and incur the expenses associated with finding buyers.

The crux of the problem is that the real estate market has a relatively complex structure and the fairness of the arrangement between the listing agent and the seller/landlord can affect the effectiveness of the marketing effort. For example, a fair commission can be the to depend upon whether it is a buyers' market or a sellers' market for the particular interest in real property involved. Moreover, fairness can be easily compromised due to the imperfect nature of the market involved, insofar as real estate agents typically have much more information about current and expected market factors as compared to homeowners and even many, particularly smaller, landlords.

In accordance with the invention, it has been recognized that a marketplace which facilitates the formation of relationships between listing agents and sellers, not just on the basis of property information but also on other bases, for example the full spectrum of market factors and individual potential listing agent characteristics, will better serve the objective, within the context of a real estate communications system, of achieving consummation of a greater proportion of real estate transactions at good prices within a reasonable period of time.

[16] However, the judging of potential ways forward for a seller involving financial considerations, real estate agent personalities, and the consideration of property specific factors is a complex task, and one which is presently done on the basis of incomplete information, intuitive assessments and common sense. The objective of the present invention is to provide a reliable artificial intelligence apparatus and algorithm aimed at providing superior results by measuring the relevant factors, assessing seller reactions engaging the same against success in the marketplace. This is done through the collection of large amounts of data, assessment of multiple factors, selection of data to guide that assessment and a multilayer decision strategy to provide bottom-line decision guidance, identifying important parameters and their relative importance, and the highlighting of more important parameters to supplement the bottom-line decision guidance.

The inventive method, comprises receiving a plurality of property identifications associated with a plurality of properties and storing the property identifications in a property database. A plurality of sets of property attributes, each of the sets of property attributes being associated with an associated one of the plurality of properties are received and stored in the property database with associative information associating each particular set of property attributes with its associated property. A plurality of owner communication addresses, each of the owner communication addresses being associated with an associated one of the plurality of properties are received by and stored in a property owner address database with property associative information associating each owner communication address with its associated property. A plurality of agent identifications each associated with a particular agent are received and stored in an agent database. A plurality of sets of listing agent attributes, each of the sets of listing agent attributes being associated with an associated one of the agents are received and stored in the agent database with agent associative information associating each particular set of agent attributes with its associated agent. A plurality of agent communication addresses, each of the agent communication addresses being associated with an associated one of the plurality of agents are stored by the system. Each agent communication address is received and stored in a agent communication address database with agent communication address associative information associating each agent communication address with its associated property. One or more property identifications with a partial or complete set of the property attributes associated with each provided property identification are each provided to agents. The inventive system receives from a plurality of agents, provided with one or more property identifications each with a partial or complete set of the property attributes, bids to secure a listing agent representation for the sale or rental of a particular property, the bid being associated with bid information. The bid may be, for example, a fixed monetary bid, and may include potential listing agent information, and/or other parameters of the proposed agent's representation including the term of exclusivity of the representation, and the rate of commission which the agent will take as a sales commission. The bid information associated with a property identification and a agent identification may be stored in a bid information database. The bid information is communicated to the owner of the associated property together with a agent identification and agent attributes.

Optionally, each of the sets of property attributes comprise a plurality of individual property attributes, such as a selling price, a geographical indicator and a physical feature. The property database may be optionally divided into a plurality of property attribute sectors, wherein each of the individual property attribute sectors is dedicated to storing one of the individual property attributes.

In accordance with the invention, agents will search the database and bid on representing the properties in the database, and the agent submitting the bid accepted by the seller pays the seller in exchange for a period of exclusive representation.

Optionally, the providing of one or more property identifications each with a partial or complete set of the property attributes associated with each provided property identification to agents is performed by receiving from a searching agent a number of search criteria indicating searching agent selected individual property attributes and searching agent selected qualitative and/or quantitative characteristics, searching the property database and identifying potential properties of interest to the searching agent.

### BRIEF DESCRIPTION OF THE DRAWINGS

The operation of the inventive apparatus and method will become apparent from the following description taken in conjunction with the drawings, in which:

FIG. 1 is a flow chart generally illustrating the methodology of a general implementation of the present invention;

FIG. 2 is a block diagram illustrating an exemplary embodiment of the infrastructure for implementing the presentation illustrated in FIG. 1;

FIG. 3 is a block diagram illustrating a technical diagram of an embodiment of the application;

FIG. 4 is a flow chart generally illustrating the information flow of an exemplary embodiment;

FIG. 5 is a block diagram of a portion of the functionality of the inventive system dealing with the opening of a listing;

FIG. 6 is a block diagram of that portion of the inventive method dealing with initial publication of potential properties in the selection of agents for bidding according to the present invention;

FIG. 7 is a block diagram illustrating the bidding portion of the method executed and embodied in the apparatus of the present invention;

FIG. 8 is a block diagram illustrating the bid selection method embodied in the inventive apparatus;

FIG. 9 illustrates the functional structure of the inventive artificial intelligence apparatus;

FIG. 10 is a block diagram of the inventive apparatus;

FIG. 11 is an alternative embodiment of the invention illustrated in FIGS. 5-10, similar to the block diagram of the methodology of FIG. 8, showing an alternative embodiment in which the seller is presented with a comparative report; and

FIG. 12 illustrates a report generated in accordance with the alternative embodiment of FIG. 11.

### DETAILED DESCRIPTION OF THE PREFERRED EMBODIMENTS

In accordance with the invention, an artificial intelligence apparatus is provided for assessing, based on large amounts of data collected by the system, the desirability of seller and real estate agent options in connection with a novel financial arrangement. More particularly, the same as facilitated by a multilayered deep learning algorithm which improves results as the system is used. In addition, the system facilitates communications functions which, in addition to providing channels of communication between human participants, also serves the dual function of collecting data, and presenting data and artificially reasoned guidance indications.

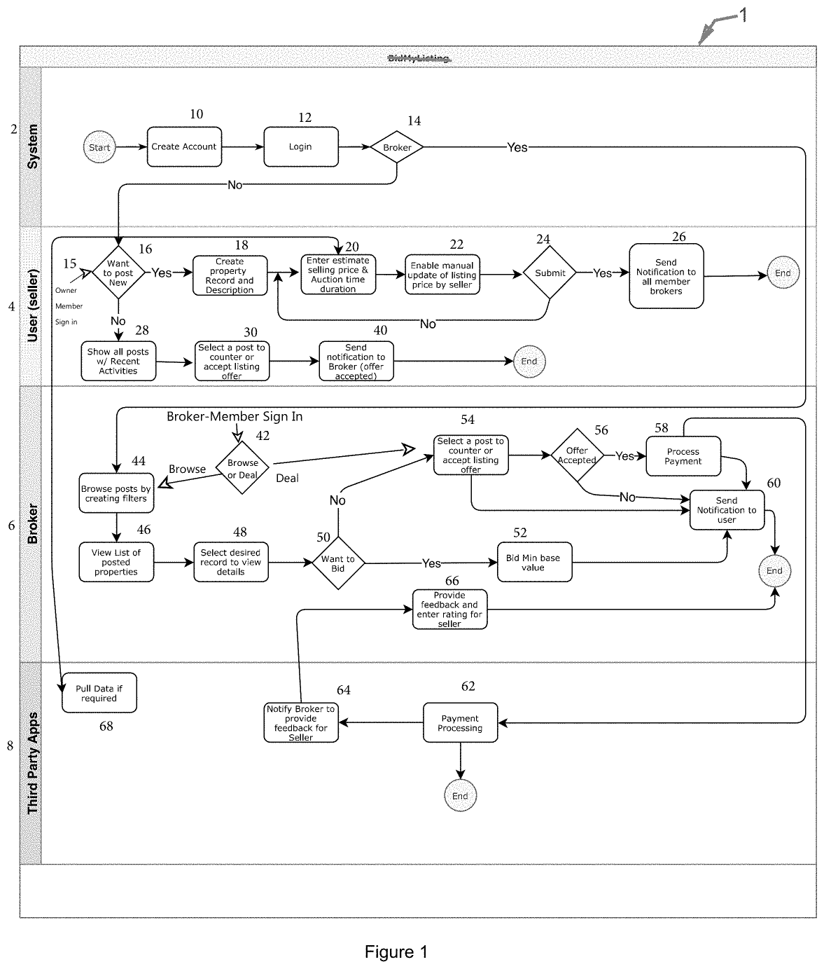

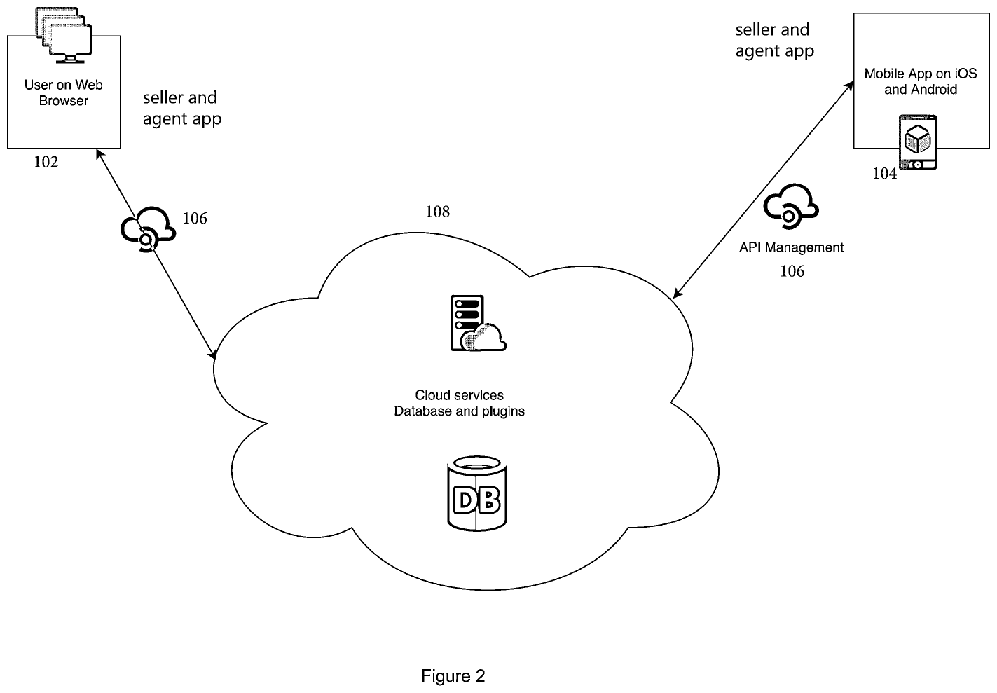

One may begin to understand the inventive system, as diagrammed in FIGS. 1 and 2, where both homeowners and real estate agents are provided with a trading and negotiation platform capable of nationwide and/or international reach. More particularly, the inventive system provides an infrastructure for the valuation of agent interest, agent information collection and transmission, and a mechanism for the making of performance-enhanced contracts for exclusive and non-exclusive listing agreements for buying, selling and leasing, for example, residential and commercial real estate. More particularly, the inventive method implements and gathers data from bidding-like/auction-like information exchanges, offers and acceptances with the object of implementing performance-enhanced contracts for exclusive and non-exclusive listing agreements.

The result is to provide the numerous benefits to both homeowners and agents, for example commercial and residential real estate agents. In this specification, it is to be understood that references to selling transactions between a seller and buyer are to be understood as applicable to analogous transactions, that is, for example, applicable to leasing transactions between lessors and lessees, and vice versa.

In accordance with the invention, the seller or lessor posts a home or other property on either a web platform or using an app. The posting includes a description of the listing including but not limited to such things as home value, home listing price, suggested starting bidding price, location, photos, videos, square footage, number of bedrooms and bathrooms, school district, taxes, and so forth.

The posting of the seller's home or property made available to all real estate agents (or optionally a selected group of real estate agents, for example, subscribers to the inventive system, or agents in a given locality). Optionally, the posting can be made available worldwide or in a limited geographic region. Upon accessing a posting, a real estate agent is given the opportunity to bid on and buy, for example, the right to represent the owner on an exclusive or non-exclusive basis in the selling or leasing of a home or other property for an agreed upon period of time, for example periods of time ranging from three months to 24 months. Optionally, the exclusivity may be limited to sales above a set price, leaving the owner to make a sale at a lower price.

In accordance with the preferred embodiment, the inventive system may comprise a website and communications infrastructure, or alternatively an app enabled over the Internet. In addition, going beyond an information exchange function, the inventive apparatus implements actions associated with a sale (for example, sale of a right to sell). However, the inventive apparatus, optionally, is not involved in any capacity in the actual buying and selling of the home or other property. Rather the focus of the inventive apparatus is to act as a platform to implement the sale of listing agreements at fair market value in a bidding-like process.

In accordance with the invention, a seller is able to monetize as an asset his listing agreement. He is thus paid for assigning to a real estate agent the right to sell or lease a property or home. This compensation to the homeowner or property owner, which is optimized on the inventive platform, is in lieu of the traditional approach of the seller giving the listing agreement to a real estate agent or investor at no cost. At the same time, an artificial intelligence algorithm guides both the real estate agent and the seller based on prior transaction data, data selection, data normalization and bottom line valuations and recommendations.

Thus, in accordance with the invention, the seller is able to showcase a home in front of real estate agents and investors, for example, worldwide, to, for example, bid on or, alternatively, outright buy the rights to listings, or combination of the two approaches. The payment to the seller for the right to list ensures that the seller engages an agent or investor who has an economic investment in seeing the home or property sell. It also potentially can attract only agents who believe they can efficiently sell the home or property.

This process de-risks the sellers exposure to hiring the wrong real estate agent to sell their home or property. The premise is based on the consequences which follow when a real estate agent has invested his own money into buying the right to sell or lease a home or property. Such agreements can be made with a high degree of confidence because the investment made by the real estate agent carries an implication that the agent has made an assessment that there can be a successful effort.

With the benefit of the inventive system, investors and real estate agents can access potential clients without the cost of the traditional advertising of their services to large numbers of people, only a few of whom may be looking for their services. Instead, financial resources can be used to invest in the exact inventory they are most likely to be able to monetize and on advertising and other efforts more likely correlated to their client's needs and objectives.

While today many real estate agents build their business other than through general advertising, for example by “referrals” or “word of mouth,” such efforts are not predictable or scalable. The inventive system allows real estate agents the ability to access and buy potential inventory while providing a direct economic benefit to the seller. It also provides the seller with a real estate agent who is enhancedly motivated to achieve seller objectives due to monetary investment in the same, particularly when exclusivity is time limited. The inventive infrastructure makes possible novel matrices of relationships which may vary over time and allow high performing agents the opportunity to better serve owners and investors.

In accordance with a particularly preferred embodiment of the invention, the operator of the inventive system (“system operator”) pays an agreed to amount of compensation to, for example, a homeowner. The homeowner agrees that for a period of, for example, thirty days the system operator has the right to make an agreement appointing a real estate agent to represent the homeowner in, for example, the sale or leasing of the property. Of course, other periods of time may be employed, such as a 60 day bidding period.

During that thirty day period, the system operator lists information regarding the property and the nature of the engagement desired by the homeowner on the system and makes the same available to real estate agent subscribers to the platform provided by the inventive system. During that thirty day period, real estate agent subscribers bid for the homeowner's listing.

In accordance with an embodiment of the invention, the homeowner is advised of bids as they occur, for example by email. Alternatively, bids may be reported periodically, for example once a day by email. Yet another alternative is to make bidding information available to the homeowner by posting the same on the account of the homeowner on the inventive system.

Optionally, at any point during the bidding process, the homeowner can stop the process by accepting a bid. It is contemplated that bid information sent to the homeowner may include such things as the duration of exclusivity that the real estate agent is seeking, the commission that the real estate agent is seeking, the identity of the real estate agent, office locations, number of agents, and so forth.

In accordance with one alternative embodiment of the invention, it is contemplated that the homeowner may specify certain criteria, for example, such parameters as the duration of exclusivity that the real estate agent will be given, the commission that the real estate agent will receive when the property is sold, and so forth. At the end of the thirty day period, if the homeowner has not accepted one of the bids made by the real estate agents, the system evaluates bids made and selects the closest match to the parameters specified by the homeowner, and gives the closest matching real estate agent the right to represent the property for the agreed to period of time, commission and so forth.

In accordance with the invention, it is contemplated that the system will be funded by real estate agents who pay the system operator for the information gathering services provided by the system operator. Such payment may take the form of a yearly membership, or payments made for the successful use of information provided by the system operator, for example, use of that information by the real estate agent in the form of the real estate agent accepting the representation of the homeowner. In accordance with the invention it is contemplated that the information gathering fee paid by the real estate agent is not refundable to the real estate agent insofar as potentially valuable information has been provided by the system operator.

The operation of an exemplary embodiment of the inventive system may be seen with reference to FIG. 1, which depicts a flow chart illustrating the methodology 1 of a general implementation of the present invention. Referring to FIG. 1, the system associated methodology in step group 2 implements account creation at step 10 for potential members, including but not limited to sellers and agents. During account creation, would-be members provide basic information, including whether they are real estate professionals or property owners seeking to use the inventive system to sell or lease property. Once registered as a member, a real estate professional or property owner may log into the system. In this disclosure, the term “seller” is used for convenience in description but is meant to include individuals who are interested in leasing out a property.

The inventive system enables login at step 12. This enables the system to be used by sellers in step group 4 and agents in step group 6. Having identified themselves as real estate professionals or property owners at account creation at step 10, the inventive method 1 provides for login at step 12. Account verification 14 is used to determine whether the member signing in is a property owner, for example a seller, or a real estate professionals such as a agent who executes in connection with step group 6. Depending upon whether the member is a property owner or a real estate professional, the member is routed through the appropriate subsequent method steps and provided with the appropriate functionality and access to post information and see appropriate posted information.

Seller member sign in at step 15 provides a seller with access to a user dashboard for creating a new post at new property posting step 18, and to view current posts and recent activity at review step 28. New posts created at step 18 include creating a property record and description, entering auction parameters at step 20 such as estimated selling price, auction time duration, and location, with the ability to enable manual update of listing price by the seller at step 22. Upon completion the seller can check his entries at submission step 24 and if acceptable submit the prepared or amended post and notify agents at notification step 26. Conversely, if the user wishes to change some of the data, he can otherwise return to post or amend data.

Seller (or lessor) member sign in at step 15, further allows the seller to access all post data and recent activities at step 28, including the ability to interact with listing offers at step 30 such as accepting or countering offers. When accepted, a notification, at notification step 40, is sent to the agent account associated with the offer being accepted.

As stated above, a seller signs up by entering the seller's home or property address, price, and other user information, which will create a user for the inventive system and allow the submission of listing information, subject to amendment at a future date. From signing in or log in, the seller is led to the dashboard where he can resume editing the listing information, delete, or view current published listings. In accordance with the invention, it is contemplated that in order to publish a listing, the seller must enter information into certain required fields, for example, financial and address details. Optionally, a 72-hour auction starts as soon as the seller publishes the listing. In accordance with the invention, optionally, the parameters initially entered by the user may be varied at will. Optionally, the system may limit the range of variation, or prevent the editing of certain informational items. The seller can view all incoming bids and has the ability to accept any bid during the period.

A separate methodological sequence is followed in the case where the member who has signed in is a real estate professional. If account verification 14 determines that the member is an agent, the member is given access to agent-member methodology and information. Broker and agent members are signed in at sign-in step 42 after which the agent is given the opportunity to either search existing listings or execute a communication respecting a listing.

More particularly, agent member sign in step 42 provides access to agent data including but not limited to the ability to proceed to browsing step 44 to search and view listings created by member-sellers. Such browsing may be enhanced by the creation of filters which lower the number of hits while increasing their relevancy on average. Likewise, the system provides the opportunity at deal 54 for the agent member to take action on posted properties listings. This can include making an offer to a seller member to buy the rights to list the seller member's property. It can also include communications with a seller member who has engaged the agent to list the seller member's property. Posts in a search can be narrowed during browsing by using various filters such as location, price, or other property attributes. Viewing the listed properties 46 can further provide detailed and customized displays of search identified properties for presentation to the agent at step 48. This enables agent review and consideration and makes it more effective prior to making any decision to bid at step 50 to accept the offered terms, or in the event of a decision to deal, proceeding to dealing step 54.

Agents have the option when bidding at step 52 to offer a requested minimum base value for the right to represent the seller member for the listing. In such event, the system proceeds to step 60 where the seller is notified of the acceptance of his offer. In accordance with the invention, it is contemplated that the seller would not accept the agent's proposal to proceed at the minimum price for the listing until some time has passed to allow for the possibility of a higher price being bid by another agent for the opportunity to represent the seller's property.

Alternatively, the agent can proceed to dealing step 54 where the agent may counter with a higher or lower price for the right to represent the listing or accept a listing counteroffer made by the seller at step 56 or reject such an offer. If an offer/counteroffer is accepted at acceptance step 56, the payment may be internally processed at step 58 and the parties noticed. Alternatively, execution of the payment may be directed to a third-party application 8 for processing payment as detailed below. Notification prompt 60 can be triggered by various aspects of the system including but not limited to bidding, dealing, countering an offer, accepting an offer, rejecting an offer, and payment processing.

In accordance with the invention, numerous alternatives may be implemented. Agents can sign up using their brokerage information, address, as well as personal information to create their user account. Agents have the ability to add or skip the payment information during this process. Agents get access to a dashboard where listings are populated for agents to bid on or watch. Agents are able to view all nearby listings within their price and distance range. Agents can further put listings on their watchlist or start bidding. Clicking on a listing allows for a further view of property details such as home owner name, auction duration and expiry date, property value, address, photos, and bidding can begin in the detail view.

System step group 2 further has third-party app connectivity and access at step group 8, allowing for third-party applications to pull system data 68 such as transaction data, auction parameters 20, new posts 18, and relevant data to facilitate interaction between the third-party app by way of the processes in step group 8 and the system step group 2, as well as payment data at payment processing step 62 and notification data at step 64.

If an offer is accepted at step 56 the payment may be internally processed at step 58 or directed to a third-party application at step group 8 for external payment processing at step 62. After payment processing both seller and agent members may be prompted to and provide feedback on the experience using the system. In accordance with the invention, it is contemplated that such communications messaging may be implemented whereby member sellers may communicate with other member sellers, and member agents may communicate with other member agents. Optionally, the system may provide for member agents to communicate with members sellers. It is also contemplated that the system will provide for the sending of notification data to both sellers and agents. Notification data 64 can include notifications such as notifying an agent to provide feedback for a seller.

Notifications may be facilitated via SMS text message or email, and include but are not limited to the following. Seller accounts may receive notifications welcoming a member upon sign up, when a new bid on the listed property is placed, and of periods of time remaining until bidding is closed (such as 24 hours remaining until the bidding period closes and when the bidding period closes such as a 72-hour mark, 120 hours after the inspection period closes, and when an agent sends in their payment). Agent accounts may receive notifications welcoming them upon sign up, when there is a new listing in the seller's area, occurrence of a new high bidder, when the bidding period closes, and the highest bidder on a the termination of the auction.

FIG. 2 is a block diagram illustrating an exemplary embodiment of the infrastructure for implementing the presentation as illustrated in FIG. 1. A seller 4 or agent 6 may utilize the system via a web browser 102 or a mobile app 104. Web browser 102 and mobile app 104 communicate with the system database 108 including related cloud services and necessary plugins, via an API Management 106.

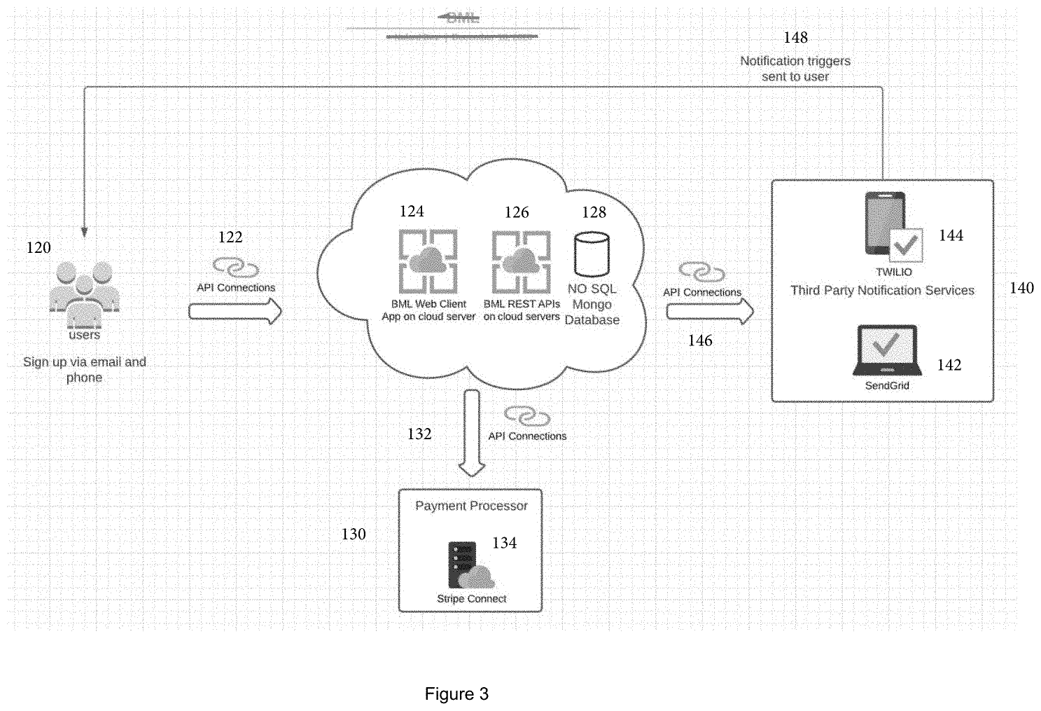

FIG. 3 depicts an exemplary embodiment where users 120 can sign up via email and phone wherein an API connection 122 provides access to a Web Client App on cloud server 124, Rest API on cloud servers 126, and/or a NO SQL Database 128 such as Mongo. Payment processing 130 can be achieved by communicating via API connection 132 to a payment processor 134 such as Stripe Connect. Concurrently, consecutively, and/or alternatively, third-party notification services 140, including but not limited to cloud-based SMTP providers 142 such as Sendgrid and/or cloud communications platform as a service 144 such as Twilio, can then be communicated with via an API connection 146 to provide notifications 148 back to the user 120.

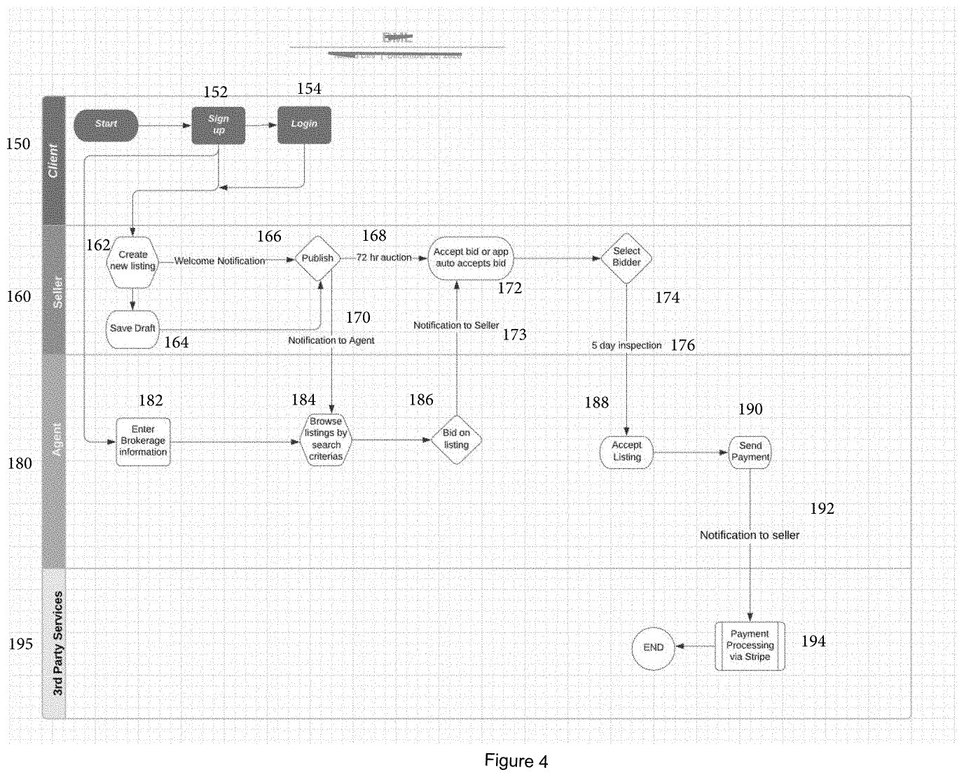

FIG. 4 depicts an alternate embodiment of the present invention where a potential user may start to use the present invention by signing up at step 152 and creating an account with personal login credentials. Once signed up, the member signs into his account by proceeding to login step 154 at which the system provides his/her account dashboard. Both initial sign up and login provides access to the user's dashboard which facilitates the appropriate capabilities depending on whether the account is associated with a seller 160 or an agent 180.

Seller 160 can create a new listing at step 162, at which point the seller 160 must choose to either save the listing (for example as a draft that may be later modified before publishing or republishing) at step 164 or to publish the listing at step 166. This will enable the listing created at step 162 to be opened for potential bidding to start. Should the seller 160 choose to publish the listing at step 162 it triggers two events. The first is a timed auction 168, in this particular embodiment lasting 72 hours, but parameters can vary. The second is a notification at step 170 sent to agents 180 informing them of a newly published listing. When bids are entered, the seller 160 can accept or auto accept the bid at step 172 based on a preapproved bid amount. Such preapproved bid amount may be a function of neighborhood, price range, age of home, etc. Once the bidder is selected at step 174 a notification is communicated to the bidding agent at step 180 giving five days to inspect.

Agent 180 can enter brokerage information at step 182 proving access to browse listings at step 184 which can be narrowed down by search criteria and notifications based on which search criteria may be activated. When a newly created listing at step 162 is published at step 166 wherein the criteria matches a search criteria of an agent 180, the agent 180 would be notified as such and can then browse the listing at step 184 based on the search criteria. Upon finding a favorable listing, the agent 180 can bid on the listing at step 186. When a bid is placed on a listing at step 186 a notification at step 173 is sent to seller 160, notifying seller 160 of the bid, upon which the seller must decide whether to accept the bid or notifying the seller that the bid was auto-accepted at step 172.

When a bid is accepted at step 172 and a bidder selected at step 174 the agent 180 has five days to inspect at step 176 before accepting the listing at step 188. When an agent 180 accepts a listing at step 188 the agent must send a payment at step 190 and notify the seller at step 192 that the listing was accepted at step 188. Payment processing at step 194 can be achieved via a third-party application 195 such as Stripe.

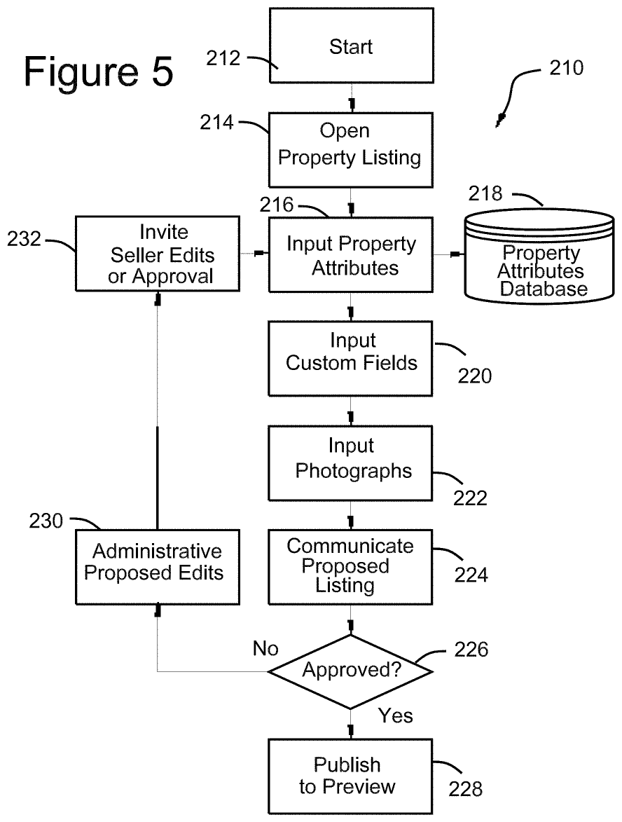

Turning to FIG. 5, a method 210, implemented on the inventive system, is initiated at step 212 with the seller of the property to be sold logging onto the inventive system and clicking on a hyperlink at step 214 to open a blank property listing graphic user interface screen with fillable blanks. The informational attributes called for in the fillable blanks are input by the property seller at step 216. In accordance with the invention, the property attributes may include type of property (for example home or apartment), street address, number of bedrooms, proposed asking price, and so forth. This information is stored for future use on the system at step 218. The owner then proceeds at step 220 to input a description of the property and any other relevant facts which the owner believes will be of interest to real estate agents.

Optionally, the seller may input photographs of the property at step 222. The proposed listing is then sent by the system to an administrator at step 224. The administrator reviews the proposed listing at step 226 and if there are no significant changes, the listing is published for preview at step 228, as will be detailed below.

Alternatively, the administrator may optionally propose edits at step 230, and then send the proposed and optionally amended listing at step 232, with or without edits, to the seller for optional amendment of the listing by the seller. The process of listing generation then continues with the input of property attributes at 216 and the subsequent steps detailed above until a proposed listing is approved for publication to preview at step 228.

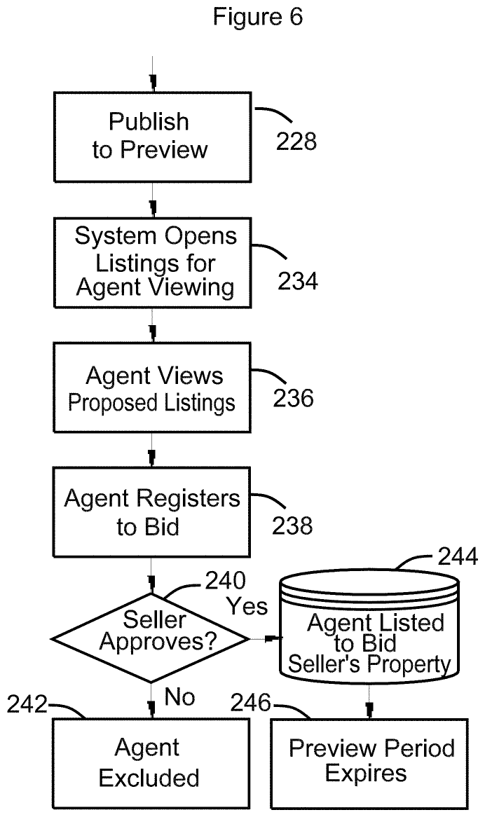

During the preview period initiated with publication at step 28, the listing is accessible to real estate agents who use the inventive system for a period of time, but the agents are not able to bid. In accordance with the invention, the preview period may have a duration of, for example, 72 hours. More particularly, referring to FIG. 6, during the preview period which initiates with publication to preview at step 228, agents are given access to search seller and inventive system operator approved property listings. During the preview period, agents can do their due diligence, such as review data on the properties, review comparables, visit the neighborhood, and so forth. Agents also have the opportunity to prospect for new listings on a regular schedule, for example once a day, without concern that an attractive listing might be taken by a competitor.

Agents may search for listings at any time in order to attempt to find listings that they may have an interest in bidding on. Searches can be done by searching for specific pieces of information on the listing, such as listing price, square footage, beds, baths, condition, etc., or by location with the use of a map display. Agents will then be shown listings in order from closest to farthest that meet their criteria. Agents also have the ability to change the sort to display the listings by highest listing price, listings with the most bids, or listings posted most recently.

During the 72 hour preview period, the listing is unlocked at step 234 and agents are able to decide whether they wish to represent the seller in the sale of the property during the marketing period. During the preview period, agents review the proposed listings at step 236. When an agent determined that a listing of a property by a seller is an attractive representation, the agent registers at step 238 to bid. This information is sent to the seller who decides at step 240 whether or not he wishes the agent to bid. This enables the seller to research the would-be agent and determine whether he wishes to be engaged in the process with that agent. If the seller decides against allowing the agent to bid, the agent is excluded by the system at step 242. Alternatively, if the seller approves the agent for bidding, that information is stored at step 244 and the agent is tagged too be given access to the bidding process after the preview period expires at step 246. Such locking out of the unapproved agents conserves system resources, reducing need for memory, RAM and communications bandwidth in the inventive system.

In accordance with the invention it is contemplated that numerous agents will register to bid at step 238 and that all or a portion of them will be listed to bid at step 244.

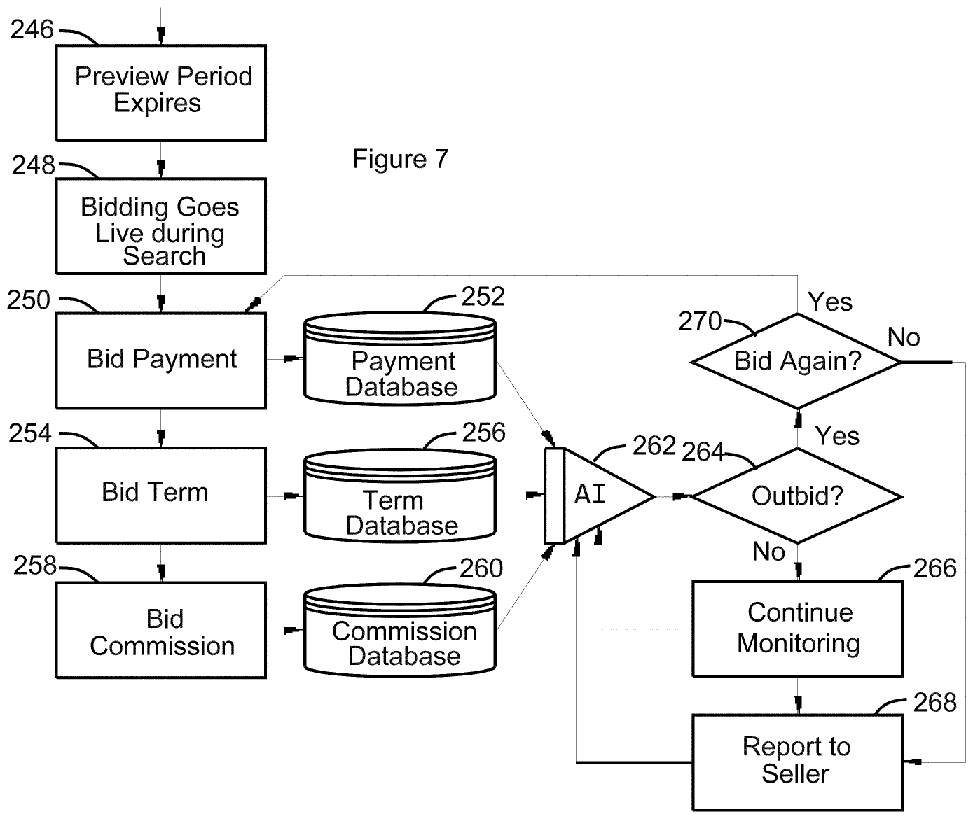

Referring to FIG. 7, upon the expiration of the preview period at step 246, the system marks the seller's listing as open to bid during searching at step 248, causing it to go live. After going live, when the bidding turns up in search results implemented in the listings stored in data bases at step 244, the opportunity of the agents to bid is indicated in the search results. Agents are then free to send bids with the three bidding parameters (term of exclusive representation, commission and price bid for listing) to the seller. In accordance with the invention, it is contemplated that agents may search for listings stored in databases at step 244. During this searching process, results may be tagged as being in the preview period or open for bidding. If an agent decides to bid on a listing the same may be done in a bid input graphic user interface presented during searching at step 248.

The real estate agent then has the opportunity at step 250 to bid the amount of money to be paid to the seller for the opportunity of representing the seller of the property as a real estate agent. The payment which is bid is stored at step 252. The real estate agent then has the opportunity at step 254 to bid the term of exclusivity for the representation of the property. The term of exclusivity which is bid is stored at step 256. Likewise, the real estate agent then has the opportunity at step 258 to bid the percentage commission which he is willing to accept upon sale of the property in exchange for his work in representing the seller of the property. The percentage commission which is bid is stored at step 260.

In accordance with the invention, steps 248 through 260 are carried out, sometimes substantially simultaneously, for a plurality of real estate agents interested in the property of the seller. Optionally, at step 262, an artificial intelligence algorithm may be used to compare bids for the same property from different agents, as is described more fully below. More particularly, the artificial intelligence algorithm scores all bids in comparison to each other to determine the bid or bids which are more or most advantageous to the seller. If a bid put in by an agent is not less advantageous than an identified advantageous group, monitoring and assessment of the bids by the artificial intelligence algorithm is continued at step 266.

Ultimately, the bid is reported to the seller at step 68, for example at the end of the bidding period. If a bid put in by an agent is or becomes less advantageous than the advantageous group, the same is reported to the agent at step 270 and the agent is given the opportunity, during the bidding period, to initiate another bid at terms more advantageous to the seller. If the agent decides to initiate another bid, he is navigated by the system through steps 250, 252 and 254 and the system proceeds as detailed above, storing and assessing the bids. Alternatively, if the agent decides to let the bid stand and not bid again at step 270, the bid is reported to the seller. The same may occur in the event that the agent has an excellent reputation and is not trying to get business by underbidding the competition. Such outbidded bids may optionally be continued to be monitored for outbidding by the artificial intelligence algorithm.

It is contemplated that the bidding period may optionally be set for one day, for example, starting at 5 AM and closing 8 PM. At the end of the bidding period, the system sends an email to the seller at step 268 Alternatively, in accordance with the invention, bids may be reported to the seller as they come in, as opposed to being held for a single report to be sent to the seller after the bidding period has closed.

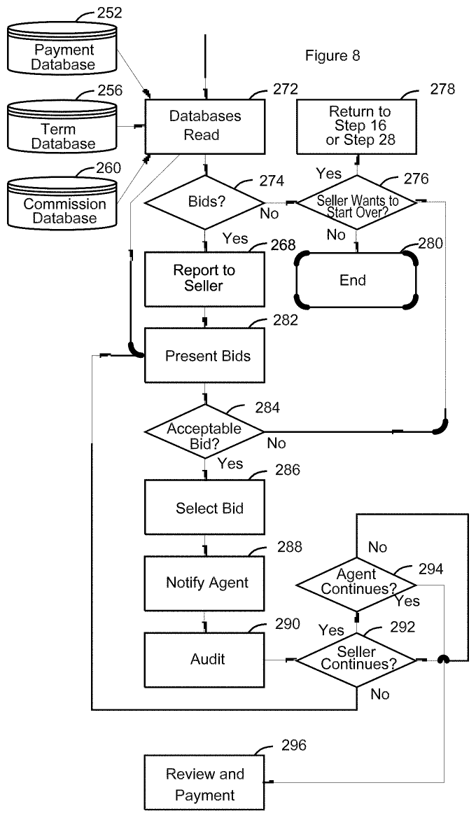

Referring to FIG. 8, after the bidding period has run, the system, at step 272 checks databases 252, 256 and 260 to determine the existence of bids. If bids are not found, at step 274 the system reports the same to the seller at step 276. If the seller wants to begin the process again the system proceeds from step 276 to return the seller to step 216 where the property attributes associated with the property are, optionally, amended and the process described above repeated, or the process is repeated without amending. Optionally, the system may present the option to proceed without amending the listing at step 276, whereupon the system proceeds directly to publish a listing for preview at step 228 and the remaining steps in the process followed as detailed above. Such direct return to step 228 reduces the need for computer resources on the system and at the local workstations of the agents and sellers.

If the seller does not wish to continue, the system proceeds to termination at step 280.

If bids are found at step 274, the system proceeds at step 282 to present the details of agent bids to the seller based upon the information in databases 252, 256 and 260. If the seller does not find one or more acceptable bids the system proceeds at step 284 to present the seller, at step 276, with the option of starting the process over again, and then proceeds as detailed above.

If acceptable bids are found, the system proceeds to step 286 where the seller is presented with a graphic user interface for the selection of one of the bids made by the agent. The system then notifies the selected agent at step 288. The system at step 290 then intermediates communication between the agent and the seller with the object of determining a date for the agent and the seller to do a walk-through of the property to be offered for sale. Subsequent to such date, the system polls the seller at step 292 to determine whether the seller wishes to continue the process. If the seller declines to continue the process with the particular agent, the system proceeds to present the remaining bids to the seller at step 282 and the process described above with respect to the steps after step 282 is followed.

If, at step 292 the seller determines to continue with the process, the system proceeds to step 294 where the system polls the agent to determine whether the agent wishes to continue with the representation. If the agent declines, the system proceeds to step 292 where the seller is given the option to continue the process.

If the agent elects to continue at step 294, the system proceeds to collect the amount which had been bid for the listing by the agent from the agent and remit a portion, for example 85%, of the same to the seller. The operator of the inventive system retains 15% of the amount paid by the agent.

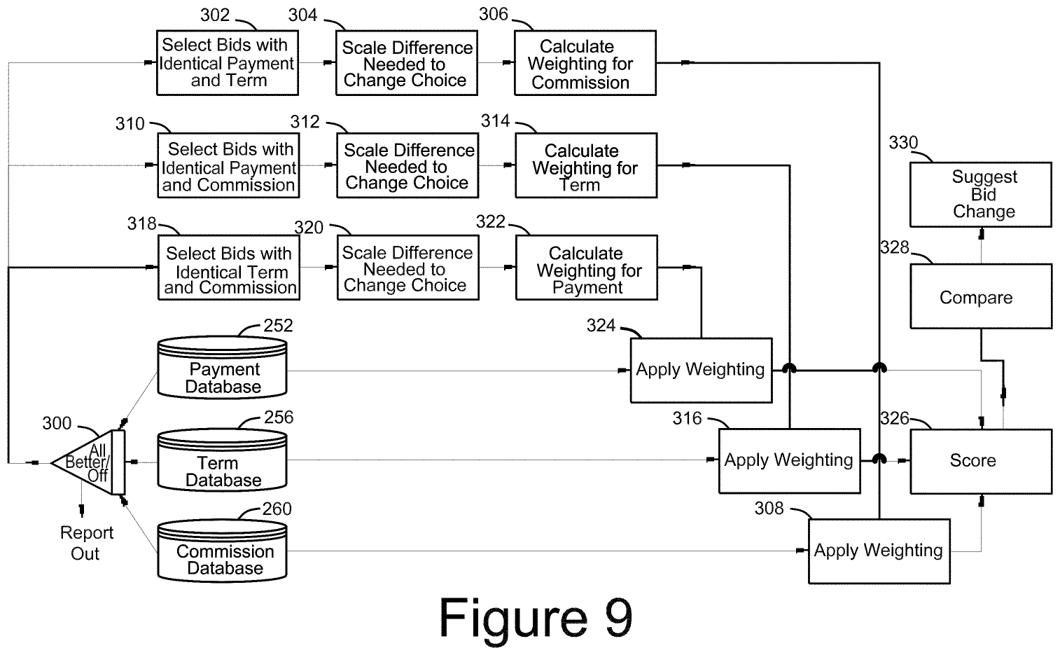

Referring to FIG. 9, optional artificial intelligence processing some or all of which may be performed at step 262 is illustrated. More particularly, once the agent has finished inputting his multielement bid at steps 252, 256 and 260, the system determines at step 100 whether or not all of the elements of the bid are better than all competing bids for the same property or are worse than all competing bids for the same property. This is a quick simple comparison which is very efficient in its use of computer storage and power. If the elements of the bid are better than all competing bids for the same property or are worse than all competing bids for the same property, this is reported out to the agent who is then given the opportunity to amend his bid at step 270.

If this simple determination is inconclusive, the system then proceeds to analyze the quality of the bid for the purpose of scoring on the basis of a comparison to the other bids and statistical data gathered from large numbers of bids stored for large numbers of properties on the system.

More particularly, in accordance with the invention, if, at step 100, the system cannot determine whether the agent has been outbid by other agents, that is by determining that the agent has bid more unfavorable terms than any other agent, the system uses historical data gathered over time, as more fully appears below.

During data collection, each time an agent makes a bid and a seller selects from a plurality of bids, the components of the bids and the selection of the seller are stored in databases 252, 256 and 260. That historical information is used at step 302 to select bids having identical or substantially identical payment and term values, where the payment is the amount paid for the listing to the seller, and the term is the term of exclusivity sought by the bidding agent. The selection is thus controlled for payment and term and the system calculates at step 304 the magnitude of the difference needed in commission to influence the seller to select on the basis of commission. This threshold may be determined based on neighborhood demographics, or the threshold may even be determined for a particular neighborhood. On the basis of this information the system then calculates at step 306 a weighting factor for commission. This weighting factor is then applied at step 308 to the commission offered to create the commission scoring component.

The historical information is also used at step 310 to select bids having identical or substantially identical payment and commission values, where the payment is the amount paid for the listing to the seller, and the commission is the commission offered by the bidding agent. This selection is thus controlled for payment and commission and the system calculates at step 312 the magnitude of the difference needed in terms of exclusivity to influence the seller to select on the basis of the term of exclusivity. This threshold may be determined based on neighborhood demographics, or the threshold may even be determined for a particular neighborhood. On the basis of this information the system then calculates at step 314 a weighting factor for term of exclusivity. This weighting factor is then applied at step 316 to the term sought to create the term scoring component.

The historical information is also used at step 318 to select bids having identical or substantially identical term and commission values. This selection is thus controlled for term and commission and the system calculates at step 320 the magnitude of the difference needed in payment to influence the seller to select on the basis of the payment. Likewise, this threshold may be determined based on neighborhood demographics, or the threshold may even be determined for a particular neighborhood. On the basis of this information the system then calculates at step 322 a weighting factor for the amount of the payment. This weighting factor is then applied at step 324 to the term sought to create the term scoring component.

At step 326, the weighted the terms are scored, for example by simple addition. In the event that the score of a particular agent is below that of the other bids by a predetermined threshold, the system at step 328 then reports to the agent that he has been outbid. Optionally, at step 330, the system can also report if a bid is lower than the average accepted bid by a second predetermined threshold, enabling the agent to make a bid which is more likely to be accepted.

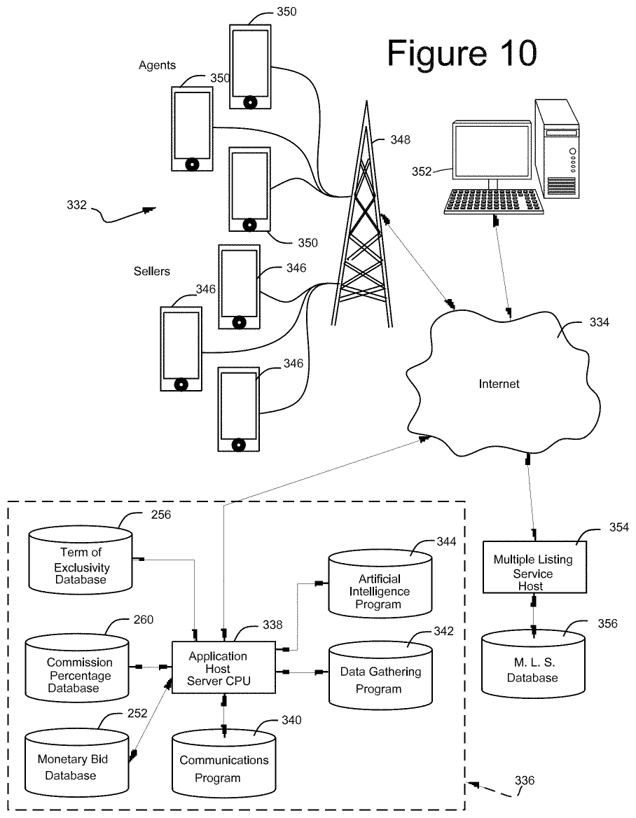

Turning to FIG. 10, a system 332 for implementing the method of FIGS. 5-9 is illustrated. System 332 is based in a publicly accessible network, such as the Internet 334. The inventive system is hosted by a computer 336 which comprises a central processing unit (“CPU”), more particularly CPU 338 in FIG. 10. CPU 338 is programmed by software comprising a plurality of subroutines for the purpose of carrying out the steps of the method described in connection with FIGS. 5-9 through the use of communications execution software 340. Data-gathering software 342 controls CPU 338 in order to implement data-gathering and related functions. Artificial intelligence and related functions are provided by artificial intelligence software 344. Software 340, 342 and 344 may be stored on the hard drive associated with CPU 338. CPU 338.

The functionality required by the method described in connection with FIGS. 5-9 is enabled by the provision of a plurality of databases dealing with the storage and retrieval of information related to the system, including the monetary bid, term of exclusivity and commission percentage information stored at steps 252, 256 and 260. The databases associated with steps 252, 256 and 260 are used for the storage of information as well as the outputting of information for the purpose of executing financial, communications and other aspects of the inventive method, as well as to serve as an ever-growing source of data for the artificial intelligence aspects of the inventive hardware illustrated in FIG. 10.

A plurality of seller's smartphones 346 are connected to the Internet 334 by a cellular carrier 348, allowing them to interface with the server 336. Similarly, a plurality of agent's smartphones 350 are connected by a carrier to Internet 334. Such connection enables execution of the steps of the method illustrated in FIGS. 5-9. Similarly, agents, sellers and others may connect to the system using a desktop computing system 352 which is connected to the Internet by an Internet service provider.

Optionally, system 332 may provide for server 336 communicating with the server 354 of a multiple listing service enabling access to the database 356 of the multiple listing service.

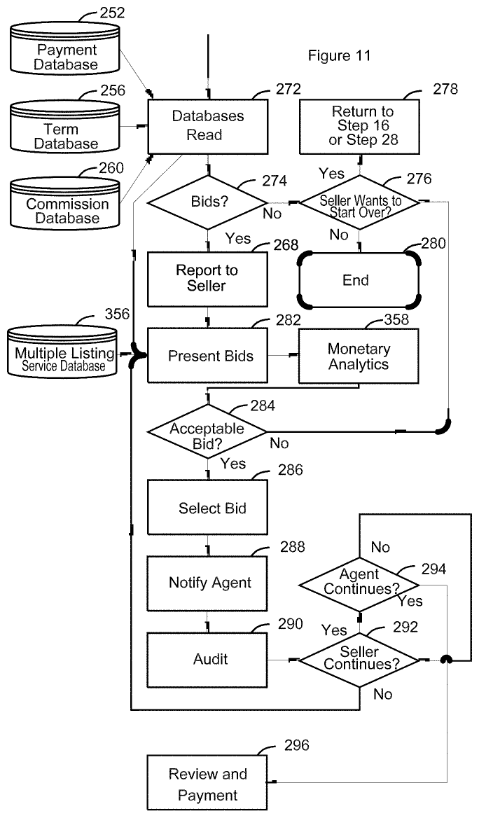

Referring to FIG. 11, in accordance with an alternative embodiment of the invention, after being presented with the particulars of bids at step 282, the system proceeds to evaluate the business using objective rules which consider monetary factors. More particularly, proceeding upon the assumption that a particular bid, if accepted, will result in the sale of the property in a short time, bids can be evaluated from a monetary standpoint. For example, assuming sale at the asking price, net proceeds to the seller can be calculated by subtracting the price paid by the agent for the representation and the commission from the selling price.

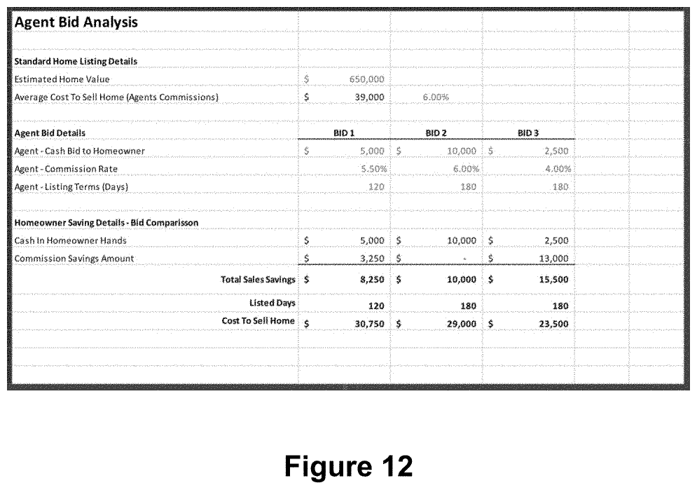

These objective criteria may be reported to the seller at step 358, for example in the form of the report of FIG. 12 which shows an objective monetary comparison of three different bids. More particularly, the monetary cost of the three different bids is laid out for easy evaluation. As illustrated, in the first bid, the commission rate is only 5½%, but the agent is only paying $5000 for the listing, resulting in a cost of sale of $30,750. In comparison, even though the second bid has a substantially higher interest rate of 6%, and the homeowner is receiving $10,000 for the listing, there is a lower cost to sell. The third bid presents an even more favorable scenario for the seller where a 4% commission is being taken with a bid of $2500 for the right to represent the seller, resulting in a cost to the seller of $23,500. In order to assist in comparative evaluation the periods of exclusivity are also presented and the advisability of a longer or shorter period of exclusivity may be judged more easily.

Optionally, in accordance with another embodiment of the invention, the seller may be presented with multiple listing service data on the agent, perhaps going back three or seven years. Such data may include the number of houses sold by the bidding agent 1) in the neighborhood of the seller's property, 2) in the price bracket of the seller's property, 3) within the bid period of exclusivity, 4) within a shorter-term, and/or 5) other factors deemed relevant. The consent of the bidding agent may be needed for some or all of this data if it is to be drawn from information confidentially maintained by the multiple listing service. It is contemplated that agents would give such consent as a condition to being given access to the system of the present invention. Once such permission is given, in accordance with the method of the present invention, information in the multiple listing service database 316 may be input for presentation to the seller at step 282 for integration with the monetary analysis of step 358, as illustrated in FIG. 11. As shown in FIG. 10, information and database 356 is made available over the Internet by the server 354 of the multiple listing service.

While illustrative embodiments of the invention have been described, it is noted that various modifications will be apparent to those of ordinary skill in the art in view of the above description and drawings. For example, one or more of the features disclosed in connection with the embodiment of FIGS. 1-4 may, optionally, be implemented in the embodiment of FIGS. 5-10. Such modifications are within the scope of the invention which is limited and defined only by the following claims.

What is claimed:

1. An artificially intelligent communications apparatus, comprising:
(a) a central processing unit;
(b) a first database storing a numerically quantifiable first attribute, said first database being in communication with said central processing unit;
(c) a second database storing a numerically quantifiable second attribute, said second database being in communication with said central processing unit;
(d) a third database storing a numerically quantifiable third attribute, said third database being in communication with said central processing unit;
(e) an input communications channel for receiving a plurality of bids in a particular auction for a particular property, each of said bids comprising a numerical value for the first, second and third numerically quantifiable attributes and bid identification information;
(f) a non-volatile memory bearing a software program, said software program controlling said central processing unit:
(i) to store, for each bid, said first, second and third numerically quantifiable attributes and their associated bid identification information together with information whether the bid was selected,
(ii) for a particular auction select those bids in which said second and third numerically quantifiable attributes are the same or within a specified numerical range and store the same in a first normalized database,
(iii) for a particular auction select those bids in which said first and third numerically quantifiable attributes are the same or within a specified numerical range and store the same in a second normalized database,
(iv) for a particular auction select those bids in which said first and second numerically quantifiable attributes are the same or within a specified numerical range and store the same in a third normalized database,
(v) for said first numerically quantifiable attribute determine a magnitude of difference in said first numerically quantifiable attribute causing a bid selection compared to less favorable rejected bids within said first normalized database by comparing bids within said first normalized database to each other to generate a first marginal driver;
(vi) for said second numerically quantifiable attribute determine a magnitude of difference in said second numerically quantifiable attribute causing a bid selection compared to less favorable rejected bids within said second normalized database by comparing bids within said second normalized database to each other to generate a second marginal driver; and
(vii) for said third numerically quantifiable attribute determine a magnitude of difference in said third numerically quantifiable attribute causing a bid selection compared to less favorable rejected bids within said third normalized database by comparing bids within said third normalized database to each other to generate a third marginal driver; and
(g) comparing a selected bid from an agent to other bids on the same property to generate a suggested bid derived from a marginal driver and a numerically quantifiable attribute.

2. A method, comprising:
(a) receiving a plurality of property identifications associated with a plurality of properties and storing said property identifications in a property database;
(b) receiving a plurality of sets of property attributes, each of said sets of property attributes being associated with an associated one of said plurality of properties and storing said sets of property attributes in said property database with associative information associating each particular set of property attributes with its associated property;
(c) receiving a plurality of owner communication addresses, each of said owner communication addresses being associated with an associated one of said plurality of properties and storing each owner communication address in a property owner address database with property associative information associating each owner communication address with its associated property;
(d) receiving a plurality of agent identifications each associated with a particular agent and storing said agent identifications in a agent database;
(e) receiving a plurality of sets of agent attributes, each of said sets of listing agent attributes being associated with an associated one of said agents and storing said sets of agent attributes in said agent database with agent associative information associating each particular set of agent attributes with its associated agent; attributes comprise;
(f) receiving a plurality of agent communication addresses, each of said agent communication addresses being associated with an associated one of said plurality of agents and storing each agent communication address in a agent communication address database with agent communication address associative information associating each agent communication address with its associated property;
(g) providing one or more property identifications each with a partial or complete set of the property attributes associated with each provided property identification to agents;
(h) receiving from a plurality of agents, provided with one or more property identifications each with a partial or complete set of the property attributes, a bid to secure a listing agent representation for the sale or rental of a particular property, said bid being associated with bid information; fixed bid/monetary bid; with potential listing agent information;
(i) storing said bid information associated with a property identification and a agent identification in a bid information database; and
(j) communicating said bid information to the owner of the associated property together with a agent identification and agent attributes.

3. A method as in claim 2, wherein each of said sets of property attributes comprise a plurality of individual property attributes, such as a price, a geographical indicator and a physical feature, said property database divided into a plurality of property attribute sectors, wherein each of said individual property attributes is dedicated to storing one of said individual property attributes.

4. A method as in claim 3, wherein said providing one or more property identifications each with a partial or complete set of the property attributes associated with each provided property identification to agents is performed by receiving from a searching agent a number of search criteria indicating searching agent selected individual property attributes and searching agent selected qualitative and/or quantitative characteristics, searching said property database and identifying potential properties of interest to the searching agent.
